(19) United States
(12) Patent Application Publication
(10) Pub. No.: US 2010/0102780 A1
(43) Pub. Date: Apr. 29, 2010

(54) TIMEKEEPER DEVICE FOR A LAPTOP COMPUTER STORAGE CABINET

(76) Inventor: TUANG-HOCK KOH, Taichung City (TW)

Correspondence Address: Chien-Hui Su, P. O. Box 70-121 Taichung, Taichung City, 40899, TW

(21) Appl. No.: 12/258,448

(22) Filed: Oct. 27, 2008

(51) Int. Cl. H02J 7/04

(52) U.S. Cl. 320/155

(57) ABSTRACT

A timekeeper device for a laptop computer storage cabinet includes a microprocessor. An operating module is electrically connected to the microprocessor for adapting to input a charging period data and start to charge a laptop computer. A gateway selection module is electrically connected to the microprocessor. The gateway selection module has multiple power sockets provided for plugging the multiple laptop computers. The gateway selection module is controlled by the microprocessor to selectively conduct the multiple power sockets. A charging selection module is electrically connected to the microprocessor. The charging selection module is controlled by the microprocessor and arranged to correspond to the multiple power sockets for selecting a power socket. A display module is electrically connected to the microprocessor for showing a charging period data by the operating module.

### BACKGROUND OF THE INVENTION

1. Field of the Invention

The present invention relates to a timekeeper device, and more particularly to a timekeeper device for a laptop computer storage cabinet.

2. Description of Related Art

Persons and companies who use multiple laptop computers and electronic testing equipment often require a safe and organized way of storing the electronic devices while the connected to a power source and data connection.

A conventional cabinet for storing laptop computers includes multiple lockable drawers movably disposed therein. Each drawer is substantially parallel to an adjacent drawer. Each drawer has a back wall for receiving power cords. A sum power cord extends to each drawer for electrically connecting each power cord. A power source received inside of the conventional cabinet is connected to the sum power cord for providing power to each drawer.

However, the conventional cabinet for storing laptop computers only provides a charge effect for each laptop computer. The conventional cabinet may not to check a charging time of each laptop computer. It may not set a charging duration for precisely charging each laptop computer.

The present invention has arisen to mitigate and/or obviate the disadvantages of the conventional cabinet.

### SUMMARY OF THE INVENTION

The main objective of the present invention is to provide an improved timekeeper device for a laptop computer storage cabinet for setting a charging period data and sequentially charging multiple laptop computers.

To achieve the objective, the timekeeper device for a laptop computer storage cabinet in accordance with the present invention comprises a microprocessor. An operating module is electrically connected to the microprocessor for adapting to input a charging period data and start to charge a laptop computer. A gateway selection module is electrically connected to the microprocessor. The gateway selection module has multiple power sockets provided for plugging the multiple laptop computers. The gateway selection module is controlled by the microprocessor to selectively conduct the multiple power sockets. A charging selection module is electrically connected to the microprocessor. The charging selection module is controlled by the microprocessor and arranged to correspond to the multiple power sockets for selecting a power socket. A display module is electrically connected to the microprocessor for showing a charging period data by the operating module.

When multiple laptop computers are plugged in the power sockets of the gateway selection module, the operating module is provided for inputting a charging period data of each laptop computer and sequentially charging the multiple laptop computers. The display module shows numerals of remained charging period data and a charging status of each laptop computer.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a timekeeper device for a laptop computer storage cabinet in accordance with the present invention; and

FIG. 2 shows a panel of the timekeeper device for a laptop computer storage cabinet in accordance with the present invention.

### DETAILED DESCRIPTION OF THE INVENTION

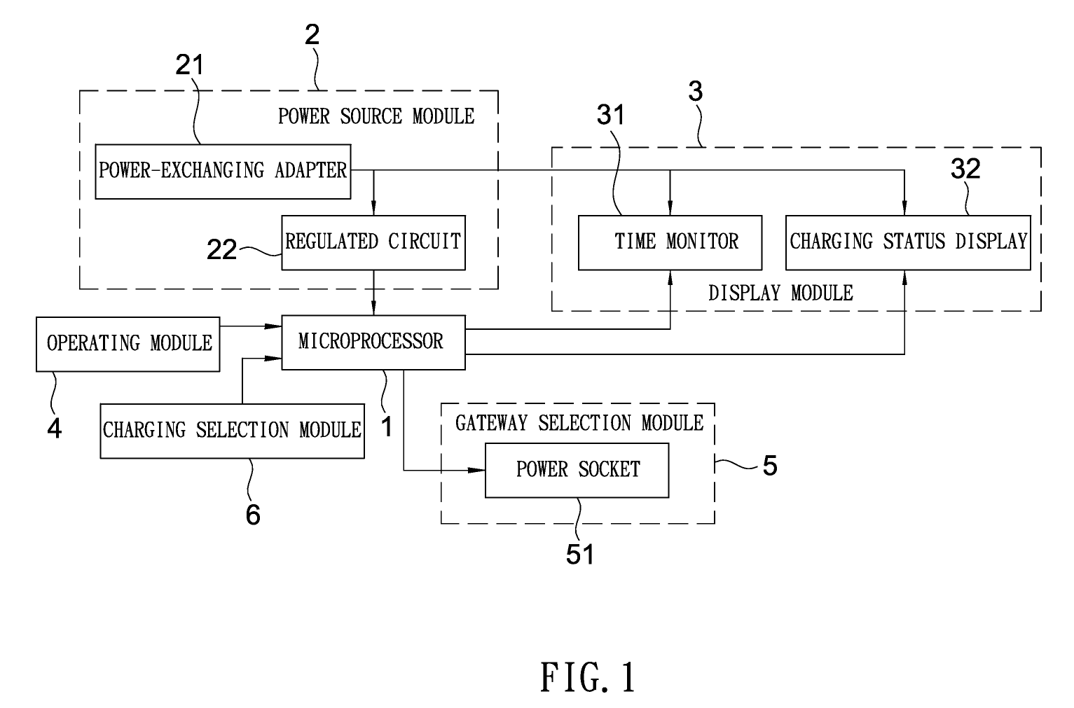

Referring to the drawings and initially to FIG. 1, it shows a flow chart of a timekeeper device for a laptop computer storage cabinet in accordance with the present invention. The timekeeper device for a laptop computer storage cabinet in accordance with the present invention comprises a microprocessor (1), a power source module (2) electrically connecting to the microprocessor (1), a display module (3) electrically connecting to the microprocessor (1), an operating module (4) electrically connecting to the microprocessor (1), a gateway selection module (5) electrically connecting to the microprocessor (1) and a charging selection module (6) electrically connecting to the microprocessor (1).

The power source module (2) includes a power-exchanging adapter (21) and a regulated circuit (22). The power-exchanging adapter (21) is electrically connected to the display module (3) and the regulated circuit (22) to exchange Alternating Current (A.C.) for Direct Current (D.C.). The regulated circuit (22) is electrically connected to the microprocessor (1) for conforming to a voltage conducted to the microprocessor (1).

The display module (3) includes a time monitor (31) and a charging status display (32) for showing a charging period data transmitted from the microprocessor (1). The time monitor (31) is composed of multiple seven-segment displays for showing numerals of the charging period data. The charging status display (32) is arranged by multiple LEDs (Lighting Emitting Diode) for showing a charging status of a laptop computer.

The operating module (4) includes two adjusting buttons (41) and a power switch (42). The adjusting buttons (41) are provided for inputting a charging period data to the microprocessor (1). The time monitor (3 1) shows the charging period data transmitted from the microprocessor (1). The power switch (42) is provided for starting to charge the laptop computer.

The gateway selection module (5) has multiple power sockets (51) provided to be plugged in the laptop computers. The gateway selection module (5) is controlled by the microprocessor (1) to selectively conduct the multiple power sockets (51) and the multiple power sockets (51).

The charging selection module (6) is arranged to correspond to the multiple power sockets (51) for selecting a power socket (51) to be charged via the microprocessor (1).

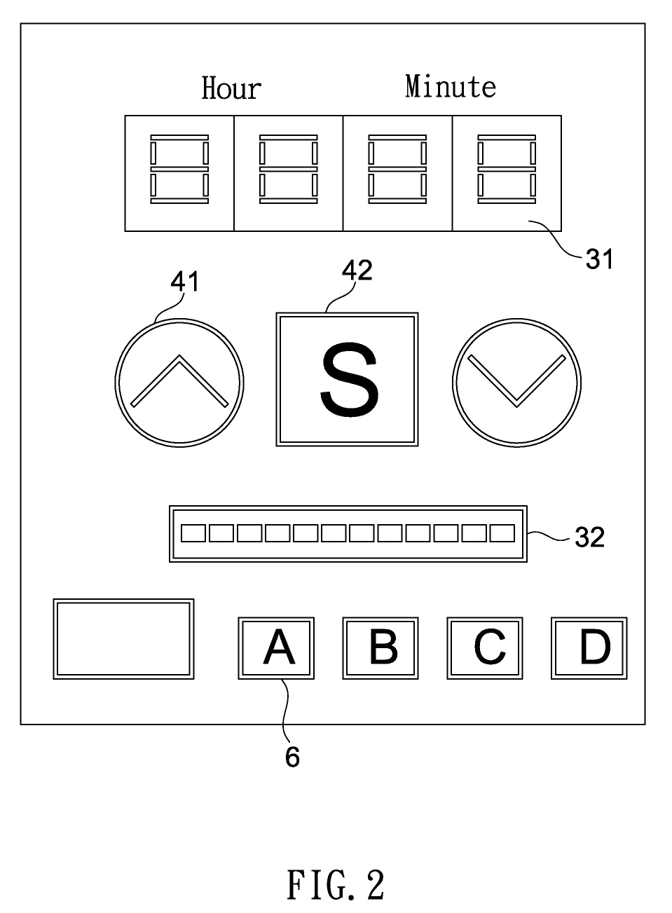

With reference to FIG. 2 that shows a panel of the timekeeper device for a laptop computer storage cabinet in accordance with the present invention. Each power socket (51) for conducting to the laptop computer is selected via the charging selection module (6). A particular charging period data for each power socket (51) is putted via the adjusting buttons (41) of the operating module (4). The charging period data of each power socket (51) is transmitted to the microprocessor (1). After pressing the power switch (42), the laptop computer connected to the earliest set power socket (51) is charged and the microprocessor (1) transmits a signal to the display module (3) for showing a remained charging period data. When the predefined charging period data is passed, the microprocessor (1) transmits a signal to the current power socket (51) for closing charging. The microprocessor (1) transmits a signal to the gateway selection module (5) for charging the next laptop computer connected to the secondary set power socket (51). In the meantime, the microprocessor (1) transmits a signal to the display module (3) for showing a remained charging period data of the secondary set power socket (51).

Although the invention has been explained in relation to its preferred embodiment, it is to be understood that many other possible modifications and variations can be made without departing from the spirit and scope of the invention as hereinafter claimed.

What is claimed is:

1. A timekeeper device for a laptop computer storage cabinet comprising:
a microprocessor;
an operating module electrically connected to the microprocessor for inputting a charging period data and adapting to start to charge a laptop computer;
a gateway selection module electrically connected to the microprocessor, the gateway selection module having multiple power sockets provided for plugging the multiple laptop computers, the gateway selection module controlled by the microprocessor to selectively conduct the multiple power sockets;
a charging selection module electrically connected to the microprocessor, the charging selection module controlled by the microprocessor and arranged to correspond to the multiple power sockets for selecting a power socket; and
a display module electrically connected to the microprocessor for showing the charging period data by the operating module;
wherein the power socket for adapting to conduct to the laptop computer is selected by the charging selection module, a charging period data inputted by the operating module and transmitting to the microprocessor for starting to charge the laptop computer, a remained charging period data showed on the display module, the microprocessor transmitting a signal to the current power socket for closing charging and transmitting a signal to the gateway selection module for charging the next laptop computer.

2. The timekeeper device for a laptop computer storage cabinet as claimed in claim 1, wherein the operating module includes two adjusting buttons and a power switch, the adjusting buttons provided for inputting a charging period data, the power switch provided for starting to charge the laptop computer.

3. The timekeeper device for a laptop computer storage cabinet as claimed in claim 1, wherein the display module includes a time monitor and a charging status display, the time monitor composed of multiple seven-segment displays for showing numerals of the charging period data, the charging status display arranged by multiple LEDs for showing a charging status of a laptop computer.

4. The timekeeper device for a laptop computer storage cabinet as claimed in claim 1 further comprising a power source module electrically connected to microprocessor, the power source module including a power-exchanging adapter and a regulated circuit, the power-exchanging adapter electrically connected to the display module and the regulated circuit to exchange Alternating Current for Direct Current, the regulated circuit electrically connected to the microprocessor for conforming to a voltage conducted to the microprocessor.
